(19) United States
(12) Patent Application Publication
(10) Pub. No.: US 2026/0310897 A1
(43) Pub. Date: Oct. 8, 2026

(54) PROFICIENCY-ADAPTIVE GENERATIVE MODEL DECODING

(71) Applicant: GDM Holding LLC, Mountain View, CA (US)

(72) Inventors: Florian Nils Hartmann, Zurich (CH); Sian Gooding, London (GB)

(21) Appl. No.: 19/098,491

(22) Filed: Apr. 2, 2025

(51) Int. Cl. G06F 40/289; G06N 3/0475

(52) U.S. Cl. CPC G06F 40/289; G06N 3/0475

(57) ABSTRACT

Implementations disclosed herein are directed to adapting decoding of generative model (GM) based on a user's language proficiency for a given language with which the user is interacting with the GM. Processor(s) of a system can: receive user input that is in the given language; process, using the GM, at least the user input to generate generic GM output that is not adapted to the user's language proficiency for the given language; process the generic GM output to generate proficiency-specific GM output that is adapted to the user's language proficiency for the given language; determine, based on the proficiency-specific GM output, responsive content; and cause the responsive content to be rendered. In generating the proficiency-specific GM output, the processor(s) can utilize a proficiency-specific model and/or a proficiency score that is specific to the user for the given language.

### BACKGROUND

This specification relates to processing data using machine learning models.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

Generative models (GMs) are increasingly used in software applications, often requiring users to interact in languages other than their primary language. This can be due to factors such as the greater availability of high-quality models in certain languages (e.g., English), a lack of models in the user's primary language, or the user's deliberate choice for language learning purposes. However, when a user's proficiency in a language utilized by a GM is low, interactions can become frustrating and inefficient, wasting computational resources, particularly given the high computational cost of some GM inference.

Existing methods to meet user's language proficiency levels using GMs, such as reinforcement learning from human feedback (RLHF), offer limited solutions as they struggle to generalize proficiency from individual queries and/or short queries and lack the capacity to encompass the vast diversity of real-world linguistic abilities. Further, prior work in natural language processing (NLP) on language proficiency classification often focuses on training separate models for different proficiency levels, resulting in significant scaling challenges and hindering personalized adaptation. Similarly, existing language simplification techniques generally fail to provide the level of personalization necessary to effectively address individual user proficiency. These limitations demonstrate a critical need for improved methods to tailor GM outputs to match individual user language proficiency levels.

Implementations disclosed herein are directed to decoding generative model (GM) output according to a user's proficiency level for a given language. Processor(s) of a system can receive user input associated with a client device of a user and in the given language; process, using a GM, GM input to generate proficiency-specific GM output that is adapted to a language proficiency of the user for the given language; determine, based on the proficiency-specific GM output, responsive content that is responsive to the user input; and cause the responsive content to be rendered at the client device of the user.

In some implementations, and in generating the proficiency-specific GM output, the processor(s) can process, using the GM, the GM input to generate generic GM output that is not adapted to the language proficiency of the user for the given language; and process, using a proficiency-specific model that is specific to the user and for the given language, the generic GM output, that is not adapted to the language proficiency of the user for the given language, to generate the proficiency-specific GM output, that is adapted to a language proficiency of the user for the given language. Put another way, the processor(s) can generate the generic GM output in a manner that is independent of the user's language proficiency in the given language, and then subsequently utilize the proficiency-specific model that is specific to the user to tailor the generic GM output to the language proficiency of the user, thereby generating the proficiency-specific GM output.

In additional or alternative implementations, the processor(s) can process, using the GM, the GM input to generate generic GM output that is not adapted to the language proficiency of the user for the given language; and filter, using a proficiency score that is specific to the user and for the given language, the generic GM output, that is not adapted to the language proficiency of the user for the given language, to generate the proficiency-specific GM output, that is adapted to a language proficiency of the user for the given language. Put another way, the processor(s) can generate the generic GM output in a manner that is independent of the user's language proficiency in the given language, and then subsequently utilize the language proficiency score that is specific to the user to filter the generic GM output to only include a subset thereof, thereby generating the proficiency-specific GM output.

These implementations can mitigate (e.g., eliminate) various drawbacks with current techniques. For example, the two-step process of building user-specific language proficiency models and using them to bias GM decoding directly addresses the issue of accurately inferring proficiency from short queries, and the user-specific language proficiency models can be updated over time based on cumulative user interactions. As another example, the proposed model-building approaches, such as using vocabulary scores and training models to predict word familiarity, offer a more scalable and personalized solution compared to training separate models for different proficiency levels. As another example, the decoding adjustments, whether through hard constraints or soft penalties described herein, allow for dynamic integration of language simplification into GM decoding, providing personalization that existing language simplification techniques lack.

As a non-limiting example of some implementations disclosed herein, consider a user interacting with a software application powered by a GM to draft an email to a co-worker. The user, whose native language is Spanish, is drafting the email in English since a recipient of the email only speaks English. Given that the user is not a native English speaker, the user's proficiency in the language may be low. According to claimed techniques, the GM can generate an initial, unadjusted response that includes complex vocabulary and grammatical structures, such as using the word “notwithstanding” and employing passive voice constructions. To tailor the response to the user's proficiency, a proficiency-specific model, trained on the user's past interactions and calibrated to the user's vocabulary and grammatical structures, identifies these elements as potentially too difficult for the user to understand the information that is being conveyed in the email. Thus, claimed techniques can adjust the GM's output, replacing “notwithstanding” with “despite” and rephrasing passive sentences into active voice. The final output presented to the user is an email with simpler language, making it easier for the user to understand by mimicking the user's vocabulary and grammatical structures while also optimizing the use of computational resources through utilization of the proficiency-specific model and/or the proficiency score during decoding.

In some implementations, the generic GM output can be a probability distribution over a sequence of word units or words, and the generic GM output can be adjusted, using the proficiency-specific model or the proficiency score, to match a user's language skills, thereby generating the proficiency-specific GM output. This can involve first creating the generic GM output without considering the user's proficiency. Then, the proficiency-specific model or the proficiency score, tailored to the user's language abilities, can analyze the generic GM output to identify a subset of words or phrases suitable for the user (e.g., a hard constraint).

For example, if the GM suggests a sentence with words like “ubiquitous” and “commensurate,” the proficiency-specific model might recognize that the user is unlikely to know these words, or these words may fail to satisfy the proficiency score. It would then select a simpler subset of the original output, replacing “ubiquitous” with “common” and “esoteric” with “obscure.” This ensures the final output is easier for the user to understand.

In some cases, the proficiency-specific model can assign a score to each word unit or word in the generic GM output, representing how likely the user is to know that word. Only words with scores above a certain proficiency threshold, or that satisfy a threshold relative to the proficiency score, may be included in the proficiency-specific GM output. Similarly, the proficiency-specific model can score sequences of words, accepting only those sequences that meet the proficiency threshold. This can be done using, for example, speculative decoding, where the proficiency-specific model explores multiple potential word sequences, phrases, sentences, etc. and then scores them based on the user's proficiency.

In other implementations, the proficiency-specific model or proficiency score may not simply select a subset of the generic GM output in generating the proficiency-specific GM output, but rather modifies the probabilities associated with different word units or words. For example, the proficiency-specific model can assign proficiency scores to each word unit or word and then penalize the probabilities of word units or words the user is unlikely to know, or penalize probabilities of word units or words the user is unlikely to know based on the proficiency score. This results in a modified probability distribution that favors simpler words, but still allows for the possibility of more complex words if they are the best fit in context (e.g., a soft penalty). For instance, if the GM assigns a high probability to the word “commensurate,” but the proficiency-specific model determines the user is unlikely to know it, the proficiency-specific model reduces the probability of “commensurate” and increases the probabilities of synonyms like “comparable” or “in line with.”

In some implementations, the processor(s) can adapt to users who speak multiple languages. For example, if a user switches from English to Spanish, the system can switch from a proficiency-specific model tailored to the user's English language and use a different proficiency-specific model tailored to the user's Spanish language skills. This allows the system to provide appropriate assistance regardless of the language being used. The proficiency-specific model used for the primary language may differ from the proficiency-specific model used for a non-primary language.

The processor(s) can also adapt to changes in a user's proficiency over time, or to different contexts. For example, if a user is interacting with the GM in a professional setting, the processor(s) might use a proficiency model that is more aligned to the user's professional vocabulary. The processor(s) may also take into account the location of the client device, the time of day, the day of the week, or the entry point through which the user input is received in determining an appropriate proficiency-specific model or proficiency score to be utilized in decoding.

In various implementations, and to further improve efficiency, the processor(s) can distill the knowledge gained from adapting to a user's proficiency back into the GM. This involves training the GM to directly generate proficiency-specific GM output that is appropriate for the user's language skills, without needing to use a separate proficiency-specific model. The original GM or an additional GM can be used for this purpose. For example, after repeatedly adjusting the GM's output for a particular user, the processor(s) can train the GM to automatically generate simpler sentences and use more common vocabulary when interacting with that user in the given language or context. This makes future interactions more efficient, as the GM can directly produce proficiency-adapted output without needing to consult the separate proficiency-specific model.

In various implementations, and prior to receiving the user input, the processor(s) can gather data from the user's past interactions with the GM to train the proficiency-specific model. This data can include, for example, the words and phrases the user has used, the topics they have asked about, any clarifying questions they have asked, and/or other information derived from these interactions that are indicative of the user's proficiency in the given language. For example, if a user frequently uses the word “okay” but never uses the word “affirmative,” the system can infer that the user is more familiar with “okay.” Similarly, if the user asks for clarification about the meaning of “ambiguous,” the system can infer that the user is less familiar with that word.

In some implementations, the training data can include both positive examples (e.g., including words and phrases the user has used) and negative examples (e.g., including words and phrases the user has asked about). The proficiency-specific model can then be trained to predict how likely the user is to know a particular word or phrase. In some versions of these implementations, this training can be done locally on the user's device. In various implementations, the proficiency-specific model can be implemented as a Low-Rank Adapter.

In some implementations, the proficiency score can be derived from the user's past interactions with the GM. For example, the system can generate a language proficiency distribution based on the user's prior interactions described above. This distribution can then be used to determine the proficiency score. Notably, the language proficiency distribution can be updated after each interaction.

The above description is provided as an overview of only some implementations disclosed herein. Those implementations, and other implementations, are described in additional detail herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts a flowchart illustrating an example method of training a proficiency-specific model that is specific to a user and that is adapted to a language proficiency of the user for a given language, in accordance with various implementations.

FIG. 3 depicts a flowchart illustrating an example method of utilizing a proficiency-specific model, that is specific to a user and that is adapted to a language proficiency of the user for a given language, to adapt decoding by a generative model (GM), in accordance with various implementations.

FIG. 4 depicts a flowchart illustrating an example method of determining a proficiency score that is specific to a user and that is adapted to a language proficiency of the user for a given language, in accordance with various implementations.

FIG. 5 depicts a flowchart illustrating an example method of utilizing a proficiency score, that is specific to a user and that is adapted to a language proficiency of the user for a given language, to adapt decoding by a generative model (GM), in accordance with various implementations.

FIG. 6A and FIG. 6B depict various non-limiting examples of adapting decoding by a generative model (GM) and based on a language proficiency of a user for a given language, in accordance with various implementations.

FIG. 7 depicts an example architecture of a computing device, in accordance with various implementations.

### DETAILED DESCRIPTION

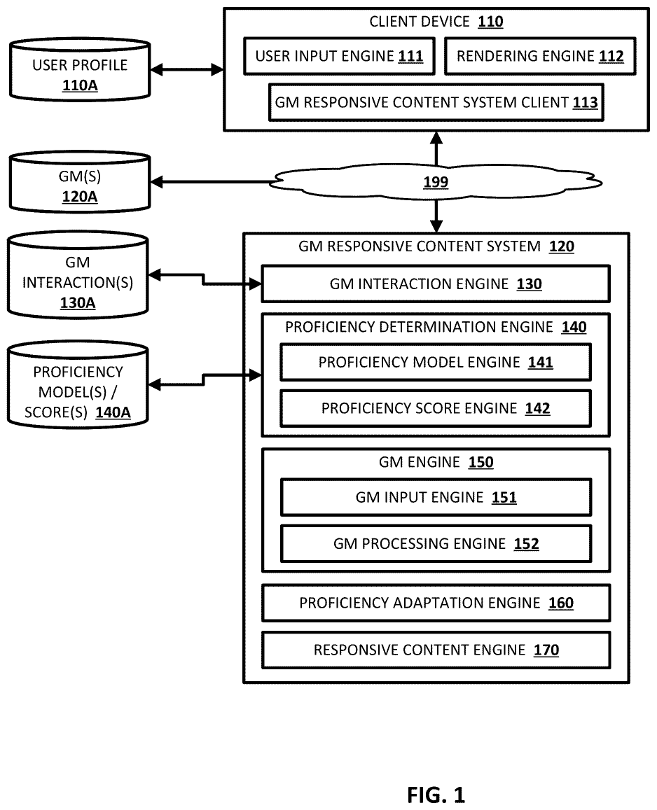

Turning now to FIG. 1, a block diagram of an example environment that demonstrates various aspects of the present disclosure, and in which implementations disclosed herein can be implemented is depicted. A client device 110 is illustrated in FIG. 1, and includes, in various implementations, a user input engine 111, a rendering engine 112, and a generative model (GM) responsive content system client 113. The client device 110 may be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, a video game console, and/or a wearable apparatus of the user that includes a computing device (e.g., a watch of the user having a computing device, glasses of the user having a computing device, a virtual or augmented reality computing device, etc.). Additional and/or alternative client devices may be provided.

The user input engine 111 can detect various types of user input at the client device 110. In some examples, the user input detected at the client device 110 can include spoken utterance(s) of a human user of the client device 110 that is detected via microphone(s) of the client device 110. In these examples, the microphone(s) of the client device 110 can generate audio data that captures the spoken utterance(s). In other examples, the user input detected at the client device 110 can include touch input of a human user of the client device 110 that is detected via user interface input device(s) (e.g., touch sensitive display(s), remote control(s), computer mouse(s), and/or stylus(es)) of the client device 110, and/or typed input detected via user interface input device(s) (e.g., touch sensitive display(s) and/or keyboard(s)) of the client device 110. In these examples, the user interface input device(s) of the client device 110 can generate textual data that captures the touch input and/or the typed input. In other examples, the user input detected at the client device 110 can include vision-based input of a human user of the client device 110 that is detected via vision component(s) (e.g., camera(s)) of the client device 110.

The rendering engine 112 can cause content and/or other output to be visually rendered for presentation to the user at the client device 110 (e.g., via a touch sensitive display or other user interface output device(s)) and/or audibly rendered for presentation to the user at the client device 110 (e.g., via speaker(s) or other user interface output device(s)). The content and/or other output can include, for example, responsive content that is responsive to user input provided by a user of the client device 110, notifications, selectable graphical elements, and/or any other content and/or output described herein.

The client device 110 is illustrated in FIG. 1 as communicatively coupled to a multimedia content system 120 over one or more networks 199 (e.g., any combination of WIFI, BLUETOOTH, or other local area networks (LANs); ethernet, the Internet, or other wide area networks (WANs); and/or any other wired or wireless networks). The GM responsive content system 120 can be implemented by, for example, a high-performance server, a cluster of high-performance servers, and/or any other computing device that is remote from the client device 110. The GM responsive content system 120 includes, in various implementations, a GM interaction engine 130, a proficiency determination engine 140, a GM engine 150, a proficiency adaptation engine 160, and a responsive content engine 170. The proficiency determination engine 140 can include various sub-engines, such as a proficiency model engine 141 and a proficiency score engine 142. Further, the GM engine 150 can include various sub-engines, such as a GM input engine 151 and a GM processing engine 152. Although FIG. 1 is depicted with respect to certain engines and sub-engines, it should be understood that is for the sake of example and is not meant to be limiting. For example, one or more of the engines and/or sub-engines depicted in FIG. 1 can be combined and/or omitted.

The client device 110 and/or the GM responsive content system 120 can access various databases and/or systems. For instance, the client device 110 and/or the multimedia content system 120 can access user profile database 110A that stores user profile data as described herein, GM(s) database 120A that stores one or more GMs as described herein, GM interaction(s) database 130A that stores prior interactions between the user and the GM, and/or proficiency model(s)/score(s) database 140A that stores proficiency-specific model(s) and/or proficiency score(s) associated with a user of the client device 110 and for various languages and/or contexts. However, it should be understood that, in various implementations, one or more of the databases may be access-restricted. For instance, in some implementations, the GM responsive content system 120 may not have access to the user profile database 110A, the GM interaction(s) database 130A, and/or the proficiency model(s)/score(s) database 140A. Although FIG. 1 is depicted with respect to certain databases and systems, it should be understood that is for the sake of example and is not meant to be limiting. For example, one or more of the databases and/or systems depicted in FIG. 1 can be combined and/or omitted.

Moreover, the client device 110 can execute the GM responsive content system client 113. An instance of the GM responsive content system client 113 can be an application that is separate from an operating system of the client device 110 (e.g., installed “on top” of the operating system)—or can alternatively be implemented directly by the operating system of the client device 110. The GM responsive content system client 113 can communicate with the GM responsive content system 120 via one or more of the networks 199 (e.g., as shown in FIG. 1). It should be understood that the GM responsive content system client 113 can implement the GM responsive content system 120 locally at the client device 110 via the GM responsive content system client 113. However, it should also be understood that one or more aspects of the GM responsive content system 120 can be implemented remotely from the client device 110 (e.g., exclusively at a high-performance server or cluster of high-performance servers), or both remotely at the GM responsive content system 120 and locally the client device 110 (e.g., via the GM responsive content system client 113) in a distributed manner.

Furthermore, the client device 110 and/or the GM responsive content system 120 may include one or more memories for storage of data and software applications, one or more processors for accessing data and executing the software applications, and other components that facilitate communication over one or more of the networks 199. In some implementations, one or more of the software applications can be installed locally at the client device 110, whereas in other implementations one or more of the software applications can be hosted remotely from the client device 110 (e.g., by one or more servers), but accessible by the client device 110 over one or more of the networks 199.

Although FIG. 1 is described with respect to a single client device having a single user, it should be understood that is for the sake of example and is not meant to be limiting. For example, one or more additional client devices of a user can also implement the techniques described herein. For instance, the client device 110, the one or more additional client devices, and/or any other computing devices of the user can form an ecosystem of devices that can employ techniques described herein. These additional client devices and/or computing devices may be in communication with the client device 110 and/or the GM responsive content system 120 (e.g., over the one or more networks 199). As another example, a given client device can be utilized by multiple users in a shared setting (e.g., a group of users, a household, etc.).

As described herein, a GM can be any machine learning model capable of generating generative vision data, generative audio data, generative textual data, and/or other forms of generative data. Some non-limiting examples of machine learning models that are capable of generating one or more forms of the generative data noted above include transformer-based machine learning models (e.g., encoder-decoder transformer models, encoder-only transformer models, decoder-only transformer models, etc. that employ an attention mechanism), diffusion-based machine learning models, recurrent neural network-based machine learning models, generative adversarial network-based machine learning models, sequence-to-sequence machine learning models, etc. Various machine learning models have demonstrated multimodal capabilities in that they are capable of processing inputs in various modalities (e.g., text-based inputs, vision-based inputs, audio-based inputs, etc.) and generating outputs in various modalities (e.g., text-based output, vision-based outputs, audio-based generative outputs, etc.).

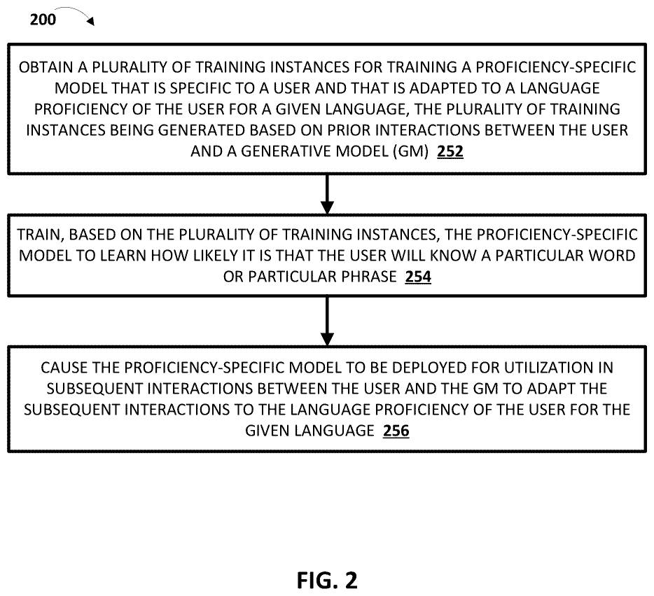

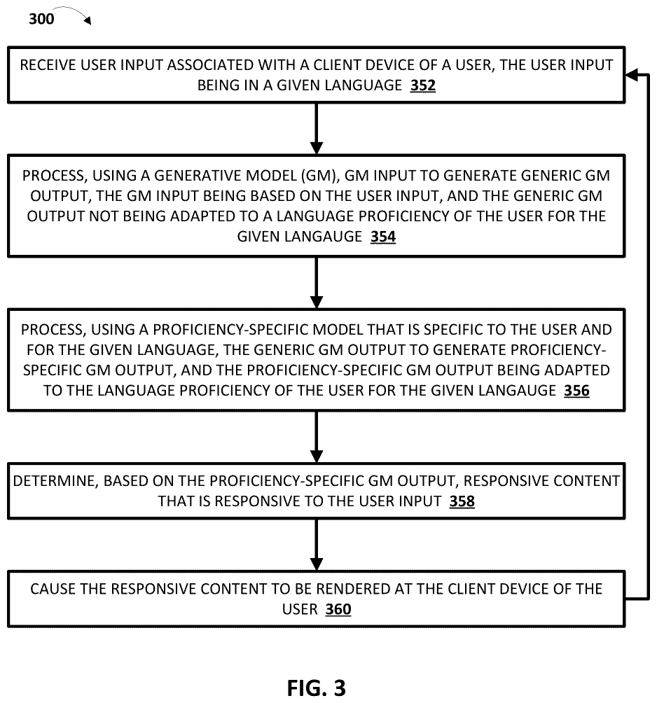

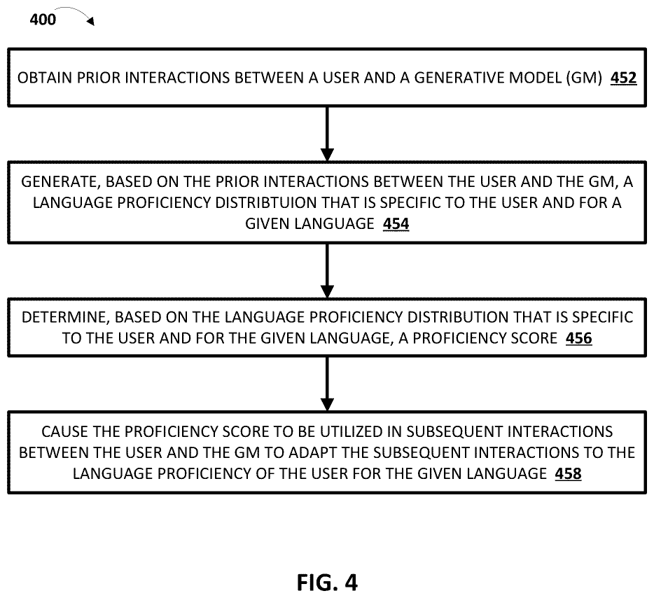

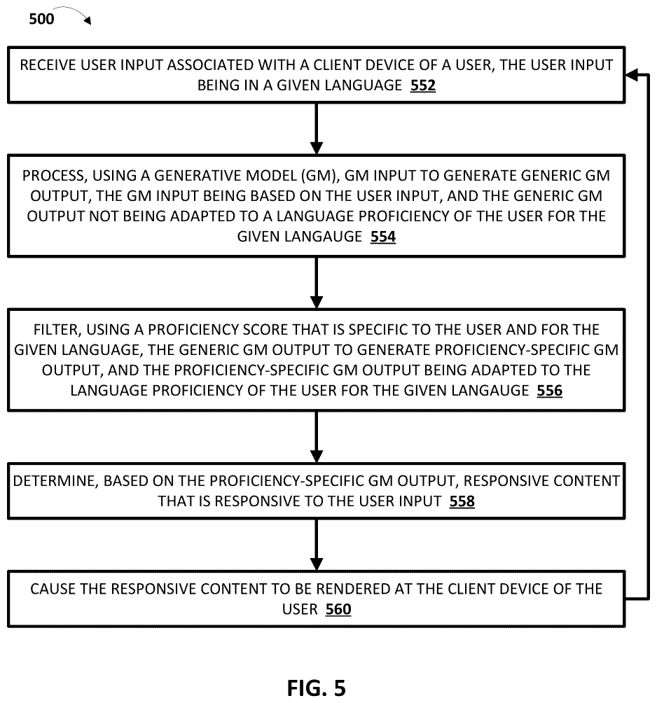

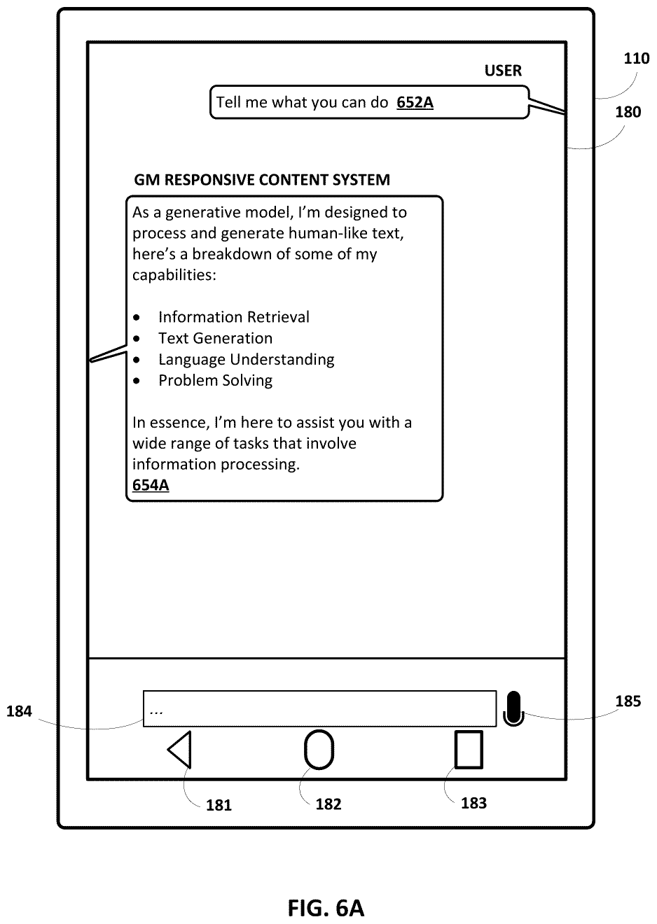

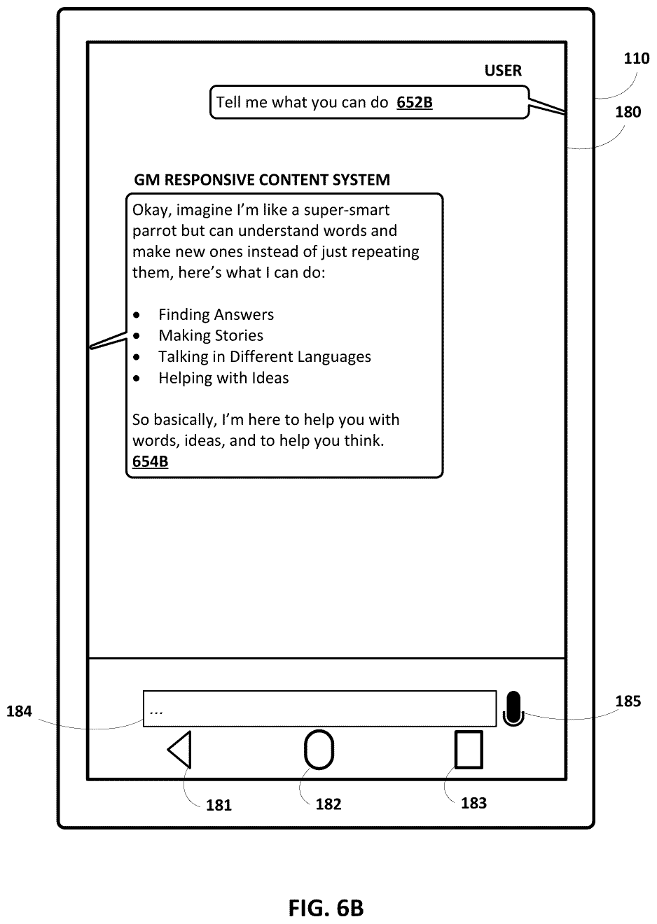

As described in more detail herein, and in response to receiving a user input directed to the GM responsive content system 120, the GM responsive content system 120 can be utilized to initially generate generic GM output that is not adapted to a language proficiency of the user of the client device 110 and for a given language in which the user input is received. However, the GM responsive content system 120 can be utilized to subsequently adapt the generic GM output, to the language proficiency of the user of the client device 110 and for the given language in which the user input is received, during a decoding stage to generate proficiency-specific GM output. This enables the GM responsive content system 120 to determine responsive content, that is responsive to the user input, that is adapted to the language proficiency of the user of the client device 110 and for the given language in which the user input is received. In some implementations, and in generating the proficiency-specific GM output, the GM responsive content system 120 can utilize a proficiency-specific model that is specific to the user and for the given language (e.g., as described with respect to FIG. 3) and that is trained based on the user's interaction with the GM (e.g., as described with respect to FIG. 2). In additional or alternative implementations, the GM responsive content system 120 can utilize a proficiency score that is specific to the user and for the given language (e.g., as described with respect to FIG. 5) and that is determined based on the user's interactions with the GM (e.g., as described with respect to FIG. 4). Additional description of the interaction engine 130, the proficiency determination engine 140, the GM engine 150, the proficiency adaptation engine 160, and the responsive content engine 170 is provided herein (e.g., with respect to FIGS. 2, 3, 4, and 5). Various non-limiting examples of utilizing the proficiency-specific model and/or the proficiency score to adapt the generic GM output to the proficiency-specific GM output are also provided herein (e.g., with respect to FIG. 6A and FIG. 6B).

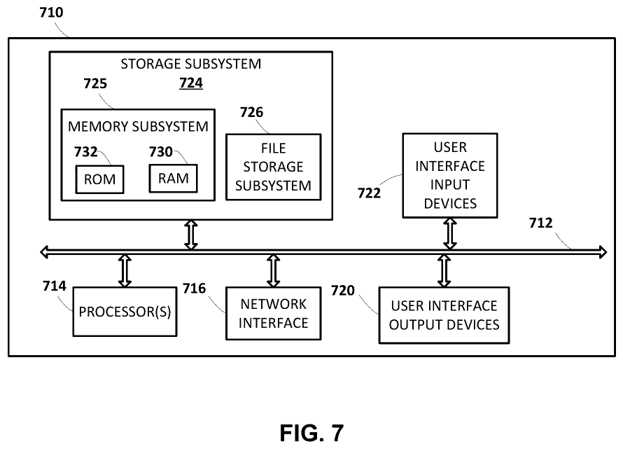

Turning now to FIG. 2, a flowchart illustrating an example method 200 of training a proficiency-specific model that is specific to a user and that is adapted to a language proficiency of the user for a given language is depicted. For convenience, the operations of the method 200 are described with reference to a system that performs the operations. This system of the method 200 includes at least one processor, memory, and/or other component(s) of computing device(s) (e.g., the client device 110 of FIG. 1 via the GM responsive content system client 113, the GM responsive content system 120 of FIG. 1, the computing device 710 of FIG. 7, and/or other computing devices). Moreover, while operations of the method 200 are shown in a particular order, this is not meant to be limiting. One or more operations may be reordered, omitted, and/or added.

At block 252, the system obtains a plurality of training instances for training a proficiency-specific model that is specific to a user and that is adapted to a language proficiency of the user for a given language, the plurality of training instances being generated based on prior interactions between the user and a generative model (GM). For example, the prior interactions may be stored in the GM interaction(s) database 130A, and the system can cause the GM interaction engine 130 to identify the prior interactions between the user and the GM. The prior interactions can include, for example, words utilized by the user in interacting with the GM, expressions utilized by the user in interacting with the GM, topics the user asks about in interacting with the GM, clarifying questions the user asks in interacting with the GM, and/or other information about prior interactions between the user and the GM. In some implementations, the GM interaction engine 130 can generate the plurality of training instances based on the prior interactions between the user and the GM. For instance, the GM interaction engine 130 can generate positive training instances based on words and/or phrases that were utilized by the user in interacting with the GM. Also, for instance, the GM interaction engine 130 can generate negative training instances based on words and/or phrases for which the user had asked clarifying questions in interacting with the GM (e.g., “what does ‘commensurate’ mean?” based on the word “commensurate” being included in prior responsive content provided for presentation to the user).

In some implementations, and in generating the plurality of training instances, the GM interaction engine 130 can obtain lexical scores by accessing certain resources, like the Cambridge Learner Dictionary, to analyze vocabulary and syntax used by the user in the prior interactions. For instance, certain dictionaries, like the Cambridge Learner Dictionary, assign concrete scores to both vocabulary and syntax. These scores can be utilized as part of the positive training instances and/or negative training instances for utilization in training the proficiency-specific model. For instance, the scores can be utilized to extrapolate whether the user will understand certain words and/or phrases, sentence structures, etc., even if the certain words and/or phrases, sentence structures, etc. do not appear in the prior interactions.

At block 254, the system trains, based on the plurality of training instances, the proficiency-specific model to learn how likely it is that the user will know a particular word or particular phrase. The proficiency-specific model can be, for example, a Low-Rank Adapter. By training the proficiency-specific model in this manner, the proficiency-specific model is trained to predict the likelihood of a user knowing specific words or phrases. For example, the proficiency-specific model can leverage the positive training instances, which consists of words, phrases, or grammar the user has successfully used, and negative training instances, which consists of words, phrases, or grammar about which the user has sought clarification. By learning from these positive training instances and negative training instances, the proficiency-specific model adjusts its parameters to accurately reflect the user's proficiency level for the given language. This enables the proficiency-specific model to tailor future GM outputs to match the user's language proficiency.

At block 256, the system causes the proficiency-specific model to be deployed for utilization in subsequent interactions between the user and the GM to adapt the subsequent interactions to the language proficiency of the user for the given language. For example, the system can store the proficiency-specific model in the proficiency model(s)/score(s) database 140A, and can cause the proficiency model engine 141 to utilize the proficiency-specific model in subsequent interactions between the user and the GM (e.g., as described with respect to FIG. 4).

Although the method 200 of FIG. 2 is described with respect to training a single proficiency-specific model for the given language, it should be understood that is for the sake of example and is not meant to be limiting. Rather, it should be understood that one or more additional and/or alternative proficiency-specific models for one or more additional languages can be trained in a similar manner. For example, a first proficiency-specific model can be trained for a first language, a second proficiency-specific model can be trained for a second language, and so on for each language that the user utilizes in interacting with the GM. Further, it should be understood that one or more additional and/or alternative proficiency-specific models can be trained for the given language, but for different contexts of the given language. For example, different proficiency-specific models could be trained to reflect different proficiency levels in specific domains, even within the given language. For instance, a user might have a high proficiency-specific model for medical terms due to their profession as a doctor, enabling them to understand complex medical explanations from the GM. Conversely, the same user might have a low proficiency-specific model for computer science concepts, resulting in the GM simplifying its output when discussing algorithms or programming. This allows the GM to tailor its language not only to general language skills but also to the user's knowledge in different areas.

In implementations where multiple proficiency-specific models are trained for the user, the training of the multiple proficiency-specific models can be performed in a parallel manner or in a serial manner through multiple iterations of the method 200 of FIG. 2. Notably, to ensure the security and privacy of user data, the system can cause the training of these proficiency-specific models to be performed locally on the user's device. This approach avoids transmitting sensitive interaction data to remote servers, mitigating potential privacy risks and ensuring the security of the user's prior interactions with the GM. This training process may be triggered and performed when one or more conditions are satisfied, such as during nighttime hours when the device is not actively in use, while the user's client device is connected to a charger, or upon the availability of new interaction data that warrants refinement of the proficiency-specific models.

Further, although the method 200 of FIG. 2 is described with respect to training a proficiency-specific model for the given language, it should be understood that is for the sake of example and is not meant to be limiting. In various implementations, the proficiency-specific model described herein can be the GM or an additional GM that processes the generic GM output along with instructions that are based on the language proficiency of the user for the given language. The instructions that are based on the language proficiency of the user for the given language can include, for example, a prompt for the GM or the additional GM to assess the likelihood that the user will understand words or phrases reflected by the generic GM output, a proficiency score of the user for the given language (e.g., determined as described with respect to FIG. 4), one-shot or few-shot examples (e.g., “the user knows the words: ‘despite,’ ‘common,’ ‘large city,’; the user struggled to understand the words: ‘notwithstanding,’ ‘ubiquitous,’ ‘conurbation’”), various statistics (e.g., “the user's vocabulary consists of the top 5000 most common English words”), and/or other content. By instructing the GM or the additional GM in these and other manners, the GM or the additional GM can effectively perform the same functionality as the proficiency-specific model without requiring any training of the proficiency-specific model for the user with respect to different languages and/or domains. Put another way, the GM or the additional GM can effectively employ the hard constraint or the soft penalty described herein to generate the proficiency-specific GM output.

Turning now to FIG. 3, a flowchart illustrating an example method 300 of utilizing a proficiency-specific model, that is specific to a user and that is adapted to a language proficiency of the user for a given language, to adapt decoding by a generative model (GM) is depicted. For convenience, the operations of the method 300 are described with reference to a system that performs the operations. This system of the method 300 includes at least one processor, memory, and/or other component(s) of computing device(s) (e.g., the client device 110 of FIG. 1 via the GM responsive content system client 113, the GM responsive content system 120 of FIG. 1, the computing device 710 of FIG. 7, and/or other computing devices). Moreover, while operations of the method 300 are shown in a particular order, this is not meant to be limiting. One or more operations may be reordered, omitted, and/or added.

At block 352, the system receives user input associated with a client device of a user, the user input being in a given language. For example, the user input engine 111 can detect the user, which can cause the GM responsive content system client 113 and/or the GM responsive content system 120 to initiate processing of the user input by the system. The user input can be, for example, touch input, voice input, typed input, and/or other forms of input as described herein.

At block 354, the system processes, using a generative model (GM), GM input to generate generic GM output, the GM input being based on at least the user input, and the generic GM output not being adapted to the language proficiency of the user for the given language. For example, the system can cause the GM input engine 151 to generate the GM input, and the system can cause the GM processing engine 152 to process, using the GM, the GM input to generate the generic GM output. As noted, the GM input can be based on at least the user input. However, it should be understood that the GM input can be based on additional content, such as conversation context, user context, and/or various other forms of context. In some implementations, the GM input engine 151 can tokenize the user input (and optionally any other data included in the GM input) to generate tokens for inclusion in the GM input. The generic GM output can include, for example, a probability distribution over a generic sequence of tokens, such as a generic sequence of words or word units, a generic sequence of phrases, a generic sequence of phonemes, a generic sequence of audio data or audio units, etc. Notably, the generic GM output may not be adapted to the language proficiency of the user for the given language.

At block 356, the system processes, using a proficiency-specific model that is specific to the user and for the given language, the generic GM output to generate proficiency-specific GM output, and the proficiency-specific GM output being adapted to the language proficiency of the user for the given language. For example, the system can cause the proficiency model engine 141 to identify the proficiency-specific model (e.g., from the proficiency model(s)/score(s) database 140A) to be utilized in processing the generic GM output to generate the proficiency-specific GM output. Further, the proficiency model engine 141 can process, using the proficiency-specific model, the generic GM output to generate the proficiency-specific GM output.

In some implementations, the proficiency model engine 141 can employ a hard constraint approach. Using the hard constraint approach, the proficiency model engine 141 can process, using the proficiency-specific model, the generic GM output to identify a subset of the generic sequence of tokens as a proficiency-specific sequence of tokens. Put another way, the proficiency model engine 141 may only allow tokens that score above a certain threshold on the user's proficiency model during each decoding step. For example, if a user with intermediate English proficiency asks an GM “What is the capital of the United States?”, responsive content generated using the generic GM output might be “The capital of the United States is Washington, D.C., which is a conurbation located on the banks of the Potomac River.” However, the proficiency model engine 141, recognizing that the user might not be familiar with the term “conurbation” through utilization of the proficiency-specific model, would prevent that token from being included in the proficiency-specific GM output, thus guiding the GM to generate the sentence to “The capital of the United States is Washington, D.C., which is a large city located on the Potomac River”.

In additional or alternative implementations, the proficiency model engine 141 can employ a “soft penalty” approach. With this approach, and rather than completely excluding tokens, the proficiency model engine 141 can add a penalty to a given token's score based on the user's proficiency model. This penalty reduces the likelihood of tokens that the user is unlikely to know, but still allows the GM to select them if they are necessary or convey information most efficiently. In some versions of these implementations, the magnitude of the penalty can be proportional to the output of the proficiency-specific model, where a lower proficiency score can result in a higher penalty, and vice versa. In these and other manners, the GM will be guided towards wording tailored for the user's capabilities, while still permitting output including the disallowed tokens when doing so results in more clarity or understanding. Put another way, the proficiency-specific GM output may include the generic sequence of tokens, but the probability distribution can be modified. For example, if a user with intermediate English proficiency asks an GM “What is the capital of the United States?”, the generic GM output might be “The capital of the United States is Washington, D.C., which is a conurbation located on the banks of the Potomac River.” However, the proficiency model engine 141, recognizing that the user might not be familiar with the term “conurbation” through utilization of the proficiency-specific model, would apply a penalty to that token, which may guide the GM to generate the sentence “The capital of the United States is Washington, D.C., which is a large city located on the Potomac River” instead, but the sentence could still include “conurbation”.

At block 358, the system determines, based on the proficiency-specific GM output, responsive content that is responsive to the user input. At block 360, the system causes the responsive content to be rendered at the client device of the user. For example, the system can cause the responsive content engine 170 to determine the responsive content by selecting tokens from the proficiency-specific GM output and based on the probability distribution associated with the proficiency-specific GM output. Moreover, the system can cause the rendering engine 112 to cause the responsive content to be rendered at the client device of the user (e.g., via the touch sensitive display or other user interface output device(s) of the client device).

In various implementations, the proficiency adaptation engine 160 can distill the knowledge gained from tailoring the GM output to a specific user's language proficiency back into the GM or into an additional GM. As one example, after tailoring the GM's output, the proficiency adaptation engine 160 can train the GM to generate similar proficiency-adapted text directly. By doing so, the next time that user interacts with the GM with similar inputs, the proficiency-specific model may not have to be utilized. In some versions of those implementations, if the proficiency adaptation engine 160 observes the GM generating GM output that includes the word “conurbation” (without any soft penalty) after the distillation, the proficiency adaptation engine 160 can cause the proficiency-specific model to be utilized and then re-distill the knowledge back into the GM or into the additional GM. Accordingly, even in implementations where knowledge is distilled back into the GM or into the additional GM, the proficiency adaptation engine 160 can determine there is a need to selectively utilize the proficiency-specific model.

Although the method 300 of FIG. 3 is described with respect to using the proficiency-specific model to adapt the generic GM output to the proficiency-specific GM output, it should be understood that is for the sake of example and is not meant to be limiting. For example, in additional or alternative implementations, a proficiency score can be utilized as opposed to or in addition to the proficiency-specific model to generate the proficiency-specific GM output (e.g., as described with respect to FIGS. 4 and 5).

Further, although the method 300 of FIG. 3 is described with respect to using the proficiency-specific model to adapt the generic GM output to the proficiency-specific GM output based on user input that is received, it should be understood that is for the sake of example and is not meant to be limiting. In various implementations, the operations of blocks 352, 358, and/or 360 can be omitted. For example, in some versions of those implementations, the system can obtain data from prior interactions between the user and the GM. In this example, the system can perform the operations of blocks 354 and 356 using the data obtained from one or more of the prior interactions between the user as the GM input that is processed by GM to build a library or vocabulary that is specific to the user's language proficiency for the given language. The library or vocabulary that is specific to the user's language proficiency for the given language can be utilized to distill knowledge back into the GM or into the additional GM as described above, utilized to generate additional responsive content that is responsive to user inputs, etc.

As another example, in additional or alternative versions of those implementations, the system can obtain data from an online data repository or a web search. In this example, the system can perform the operations of blocks 354 and 356 using the data obtained from the online data repository or the web search as the GM input that is processed by GM to generate content that matches the user's language proficiency for the given language. This content can be proactively provided for presentation to a user (e.g., as a notification or the like) in the same or similar manner as described with respect to the operations of block 360, but using the content instead of the responsive content.

Turning now to FIG. 4, a flowchart illustrating an example method 400 of determining a proficiency score that is specific to a user and that is adapted to a language proficiency of the user for a given language is depicted. For convenience, the operations of the method 400 are described with reference to a system that performs the operations. This system of the method 400 includes at least one processor, memory, and/or other component(s) of computing device(s) (e.g., the client device 110 of FIG. 1 via the GM responsive content system client 113, the GM responsive content system 120 of FIG. 1, the computing device 710 of FIG. 7, and/or other computing devices). Moreover, while operations of the method 400 are shown in a particular order, this is not meant to be limiting. One or more operations may be reordered, omitted, and/or added.

At block 452, the system obtains prior interactions between a user and a generative model (GM), the prior interactions may be stored in the GM interaction(s) database 130A, and the system can cause the GM interaction engine 130 to identify the prior interactions between the user and the GM. The prior interactions can include, for example, words utilized by the user in interacting with the GM, expressions utilized by the user in interacting with the GM, topics the user asks about in interacting with the GM, clarifying questions the user asks in interacting with the GM, and/or other information about prior interactions between the user and the GM.

At block 454, the system generates, based on the prior interactions between the user and the GM, a language proficiency distribution that is specific to the user and for a given language. At block 456, the system determines, based on the language proficiency distribution that is specific to the user and for the given language, a proficiency score. For example, the system can cause the proficiency score engine 142 to generate the language proficiency distribution and to determine the proficiency score based on the language proficiency distribution. In generating the language proficiency distribution, the proficiency score engine 142 can obtain lexical scores by accessing certain resources, like the Cambridge Learner Dictionary, to analyze vocabulary and syntax used by the user in the prior interactions. For instance, certain dictionaries, like the Cambridge Learner Dictionary, assign concrete scores to both vocabulary and syntax. By examining the user's lexicon in the prior interactions, the proficiency score engine 142 can build the language proficiency distribution, which can reflect the complexity of their language knowledge for the given language. Based on the language proficiency distribution, the proficiency score engine 142 can determine the proficiency score which can then be utilized to estimate the likelihood of the user understanding certain words, phrases, uses of vocabulary, etc.

At block 458, the system causes the proficiency score to be utilized in subsequent interactions between the user and the GM to adapt the subsequent interactions to the language proficiency of the user for the given language. For example, the system can store the proficiency score in the proficiency model(s)/score(s) database 140A, and can cause the proficiency score engine 142 to utilize the proficiency score in subsequent interactions between the user and the GM (e.g., as described with respect to FIG. 5).

Although the method 400 of FIG. 4 is described with respect to determining a single proficiency score for the given language, it should be understood that is for the sake of example and is not meant to be limiting. Rather, it should be understood that one or more additional and/or alternative proficiency scores for one or more additional languages can be determined in a similar manner. For example, a first proficiency score can be determined for a first language, a second proficiency score can be trained for a second language, and so on for each language that the user utilizes in interacting with the GM. Further, it should be understood that one or more additional and/or alternative proficiency scores can be determined for the given language, but for different contexts of the given language. For example, different proficiency scores could be determined to reflect different proficiency levels in specific domains, even within the given language. For instance, a user might have a high proficiency score for medical terms due to their profession as a doctor, enabling them to understand complex medical explanations from the GM. Conversely, the same user might have a low proficiency score for computer science concepts, resulting in the GM simplifying its output when discussing algorithms or programming. This allows the GM to tailor its language not only to general language skills but also to the user's knowledge in different areas.

In implementations where multiple proficiency scores are determined for the user, the determination of the multiple proficiency scores can be performed in a parallel manner or in a serial manner through multiple iterations of the method 400 of FIG. 4. Notably, to ensure the security and privacy of user data, the system can cause the determination of these proficiency scores to be performed locally on the user's device. This approach avoids transmitting sensitive interaction data to remote servers, mitigating potential privacy risks and ensuring the security of the user's prior interactions with the GM. This training process may be triggered and performed when one or more conditions are satisfied, such as during nighttime hours when the device is not actively in use, while the user's client device is connected to a charger, or upon the availability of new interaction data that warrants refinement of the proficiency scores.

Turning now to FIG. 5, a flowchart illustrating an example method 500 of utilizing a proficiency score, that is specific to a user and that is adapted to a language proficiency of the user for a given language is depicted. For convenience, the operations of the method 500 are described with reference to a system that performs the operations. This system of the method 500 includes at least one processor, memory, and/or other component(s) of computing device(s) (e.g., the client device 110 of FIG. 1 via the GM responsive content system client 113, the GM responsive content system 120 of FIG. 1, the computing device 710 of FIG. 7, and/or other computing devices). Moreover, while operations of the method 500 are shown in a particular order, this is not meant to be limiting. One or more operations may be reordered, omitted, and/or added.

At block 552, the system receives user input associated with a client device of a user, the user input being in a given language. The system can receive the user input in the same or similar manner described with respect to block 352 of the method 300 of FIG. 3.

At block 554, the system processes, using a generative model (GM), GM input to generate generic GM output, the GM input being based on at least the user input, and the generic GM output not being adapted to the language proficiency of the user for the given language. The system can process the GM input to generate the generic GM output and receive the user input in the same or similar manner described with respect to block 354 of the method 300 of FIG. 3.

At block 556, the system filters, using a proficiency score that is specific to the user and for the given language, the generic GM output to generate proficiency-specific GM output, and the proficiency-specific GM output being adapted to the language proficiency of the user for the given language. In contrast with block 356 of the method 300 of FIG. 3 where the system utilizes the proficiency-specific model in generating the proficiency-specific GM, at block 556, the system can utilize the proficiency score that is specific to the user and for the given language in generating the proficiency-specific GM output. For example, the system can cause the proficiency score engine 142 to identify the proficiency score (e.g., from the proficiency model(s)/score(s) database 140A) to be utilized in filtering the generic GM output to generate the proficiency-specific GM output. Further, the proficiency score engine 142 can filter, using the proficiency score, the generic GM output to generate the proficiency-specific GM output.

In some implementations, and similar to the proficiency model engine 141 described with respect to block 356 of the method 300 of FIG. 3, the proficiency score engine 142 can employ a hard constraint approach. Using the hard constraint approach, the proficiency score engine 142 can filter, using the proficiency score, the generic GM output to identify a subset of the generic sequence of tokens as a proficiency-specific sequence of tokens. Put another way, the proficiency score engine 142 may only allow tokens that satisfy the proficiency score during each decoding step. For example, if a user with intermediate English proficiency asks an GM “What is the capital of the United States?”, responsive content generated using the generic GM output might be “The capital of the United States is Washington, D.C., which is a conurbation located on the banks of the Potomac River.” However, the proficiency score engine 142, recognizing that the user might not be familiar with the term “conurbation” through utilization of the proficiency score, would prevent that token from being included in the proficiency-specific GM output, thus guiding the GM to generate the sentence to “The capital of the United States is Washington, D.C., which is a large city located on the Potomac River”.

In additional or alternative implementations, and also similar to the proficiency model engine 141 described with respect to block 356 of the method 300 of FIG. 3, the proficiency score engine 142 can employ a “soft penalty” approach. With this approach, and rather than completely excluding tokens, the proficiency score engine 142 can add a penalty to a given token's score based on the user's proficiency score. This penalty reduces the likelihood of tokens that the user is unlikely to know, but still allows the GM to select them if they are necessary or convey information most efficiently. In some versions of these implementations, the magnitude of the penalty can be proportional to the proficiency score, where a lower proficiency score can result in a higher penalty, and vice versa. In these and others manners, the GM will be guided towards wording tailored for the user's capabilities, while still permitting output including the disallowed tokens when doing so results in more clarity or understanding. Put another way, the proficiency-specific GM output may include the generic sequence of tokens, but the probability distribution can be modified. For example, if a user with intermediate English proficiency asks an GM “What is the capital of the United States?”, the generic GM output might be “The capital of the United States is Washington, D.C., which is a conurbation located on the banks of the Potomac River.” However, the proficiency score engine 142, recognizing that the user might not be familiar with the term “conurbation” through utilization of the score, would apply a penalty to that token, which may guide the GM to generate the sentence “The capital of the United States is Washington, D.C., which is a large city located on the Potomac River” instead, but the sentence could still include “conurbation”.

At block 558, the system determines, based on the proficiency-specific GM output, responsive content that is responsive to the user input. At block 560, the system causes the responsive content to be rendered at the client device of the user. The system can determine the responsive content that is responsive to the user input in the same or similar manner described with respect to the operations of block 358 of the method of FIG. 3. Further, the system can cause the responsive content to be rendered at the client device of the user in the same or similar manner described with respect to the operations of block 360 of the method of FIG. 3.

Similar to the method 300 of FIG. 3, in various implementations, the proficiency adaptation engine 160 can distill the knowledge gained from tailoring the GM output to a specific user's language proficiency back into the GM or into an additional GM. As one example, after tailoring the GM's output, the proficiency adaptation engine 160 can train the GM to generate similar proficiency-adapted text directly. By doing so, the next time that user interacts with the GM with similar inputs, the proficiency-specific model may not have to be utilized. As another example, when the proficiency adaptation engine 160 observes the GM generating GM output that includes the word “conurbation” (without any soft penalty), the proficiency adaptation engine 160 can cause the proficiency-specific model to be utilized.

Although the method 500 of FIG. 5 is described with respect to using the score to adapt the generic GM output to the proficiency-specific GM output, it should be understood that is for the sake of example and is not meant to be limiting. For example, in additional or alternative implementations, a proficiency-specific model can be utilized as opposed to or in addition to the proficiency score to generate the proficiency-specific GM output (e.g., as described with respect to FIGS. 2 and 3).

Further, although the method 300 of FIG. 3 is described with respect to using the proficiency score to adapt the generic GM output to the proficiency-specific GM output based on user input that is received, it should be understood that is for the sake of example and is not meant to be limiting. In various implementations, the operations of blocks 552, 558, and/or 560 can be omitted. For example, in some versions of those implementations, the system can obtain data from prior interactions between the user and the GM. In this example, the system can perform the operations of blocks 554 and 556 using the data obtained from one or more of the prior interactions between the user to build a library or vocabulary that is specific to the user's language proficiency for the given language. The library or vocabulary that is specific to the user's language proficiency for the given language can be utilized to distill knowledge back into the GM or into the additional GM as described above, utilized to generate additional responsive content that is responsive to user inputs, etc.

As another example, in additional or alternative versions of those implementations, the system can obtain data from an online data repository or a web search. In this example, the system can perform the operations of blocks 554 and 556 using the data obtained from the online data repository or the web search to generate content that matches the user's language proficiency for the given language. This content can be proactively provided for presentation to a user (e.g., as a notification or the like) in the same or similar manner as described with respect to the operations of block 560, but using the content instead of the responsive content.

Turning now to FIG. 6A and FIG. 6B, various non-limiting examples of adapting decoding by a generative model (GM) and based on a language proficiency of a user for a given language are depicted. A client device 110 (e.g., an instance of the client device 110 of FIG. 1) may include various user interface components including, for example, microphone(s) to generate audio data based on spoken utterances and/or other audible input, speaker(s) to audibly render synthesized speech and/or other audible output, and/or a display 180 to visually render visual output. Further, the display 180 of the client device 110 can include various system interface elements 181, 182, and 183 (e.g., hardware and/or software interface elements) that may be interacted with by a user of the client device 110 to cause the client device 110 to perform one or more actions. The display 180 of the client device 110 enables the user to interact with content rendered on the display 180 by touch input (e.g., by directing user input to the display 180 or portions thereof (e.g., to a text entry box 184, to a keyboard (not depicted), or to other portions of the display 180)) and/or by spoken input (e.g., by selecting microphone interface element 185- or just by speaking without necessarily selecting the microphone interface element 185 (i.e., an automated assistant may monitor for one or more terms or phrases, gesture(s) gaze(s), mouth movement(s), lip movement(s), and/or other conditions to activate spoken input) at the client device 110). Although the client device 110 depicted in FIG. 6A and FIG. 6B is a mobile phone, it should be understood that is for the sake of example and is not meant to be limiting. For example, the client device 110 may be a standalone speaker with a display, a standalone speaker without a display, a home automation device, an in-vehicle system, a laptop, a desktop computer, and/or any other device capable of executing an automated assistant to engage in a human-to-computer dialog session with the user of the client device 110.

Referring specifically to FIG. 6A, for the sake of example, assume that a user of the client device 110 is a computer scientist and is interacting with a GM responsive content system (e.g., the GM responsive content system 120 from FIG. 1), and assume that the user of the client device 110 provides user input 652A of “Tell me what you can do” to obtain responsive content that includes an explanation of some capabilities of the GM responsive content system. In this example, further assume that the GM responsive content system generates and renders responsive content 654A that lists various capabilities of the GM responsive content system, such as “Information Retrieval”, “Text Generation”, “Language Understanding”, and “Problem Solving”. In contrast, and referring specifically to FIG. 6B, for the sake of example, assume that the user of the client device 110 is a not a computer scientist and is interacting with a GM responsive content system (e.g., the GM responsive content system 120 from FIG. 1), and assume that the user of the client device 110 provides user input 652B of “Tell me what you can do” to obtain responsive content that includes an explanation of some capabilities of the GM responsive content system. In this example, further assume that the GM responsive content system generates and renders responsive content 654B that lists various capabilities of the GM responsive content system, such as “Finding Answers”, “Making Stories”, “Talking in Different Languages”, and “Helping with Ideas”.

Notably, in the examples of FIG. 6A and FIG. 6B, the user inputs 652A and 654B are the same-the user is asking for an explanation of some capabilities of the GM responsive content system. However, the responsive content 654A and 654B that is generated and rendered in these examples differ. The responsive content 654A and 654B that is generated and rendered in these examples can differ, for example, due to the different language proficiencies of the users with respect to the topics discussed as part of the user inputs 652A and 652B. For instance, the user with higher language proficiency with respect to computer science in the example of FIG. 6A may be able to understand the terms “Information Retrieval”, “Text Generation”, “Language Understanding”, and “Problem Solving” within the context of computer science and included in the responsive content 654A, while the user with lower language proficiency with respect to the computer science in the example of FIG. 6B may not understand the terms “Information Retrieval”, “Text Generation”, “Language Understanding”, and “Problem Solving” within the context of computer science. As a result, and through utilization of different proficiency-specific models and/or proficiency scores for these different users, the GM responsive content system may simplify the responsive content 654B by including “Finding Answers” instead of “Information Retrieval”, “Making Stories” instead of “Text Generation”, “Talking in Different Languages” instead of “Language Understanding”, and “Helping with Ideas” instead of “Problem Solving”.

In these examples, and by adapting the responsive content 654A and 654B to the language proficiency of the user and in guiding the human-to-computer dialog, instances of the users providing follow-up user inputs requesting clarity on words, phrases, syntax, grammar, etc. can be reduced, thereby conserving computational and/or network resources consumed during the interaction between the user and the GM system responsive content system. For instance, had the responsive content 654B included “Information Retrieval”, the user in the example of FIG. 6B may have provided a follow-up user input of “What is information retrieval?”. In this instance, the follow-up user input would be re-processed by the GM responsive content system to generate additional responsive content that would then be rendered for the user. However, knowing the user in the example in FIG. 6B is not a computer scientist, the GM responsive content system proactively adapts the responsive content 654B to the language proficiency of the user.

Although the examples of FIG. 6A and FIG. 6B are described with respect to adaptation of the responsive content based on one user being a computer scientist and another user not being a computer scientist, it should be understood that is for the sake of example and is not meant to be limiting. Rather, it should be that is for the sake of illustrating various techniques contemplated herein and techniques described herein can be particularly useful in scenarios where the user is interacting with the GM in a non-primary language of the user. For instance, consider a scenario where a Spanish-speaking user, whose primary language is Spanish, is interacting with a GM responsive content system that is only available in the English language. In this case, and since the user is interacting with the GM responsive content system in a non-primary language (e.g., English), the user's vocabulary, grammar, and syntax may be limited, and the generated responsive content may be difficult for them to comprehend. Therefore, the GM responsive content system can adapt the responsive content to use simplified vocabulary and phrasing that is more accessible and suitable for the user's actual level of English proficiency to optimize the interaction and objectively reduce the likelihood of follow-up user inputs requesting clarity on words, phrases, syntax, grammar, etc. being received.

Turning now to FIG. 7, a block diagram of an example computing device 710 that may optionally be utilized to perform one or more aspects of techniques described herein is depicted. In some implementations, one or more of a client device, cloud-based automated assistant component(s), and/or other component(s) may comprise one or more components of the example computing device 710.

Computing device 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 may include the logic to perform selected aspects of the methods disclosed herein, as well as to implement various components depicted in FIG. 1.

These software modules are generally executed by processor 714 alone or in combination with other processors. Memory 725 used in the storage subsystem 724 can include a number of memories including a main random access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem 712 may use multiple busses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personally identifiable information is removed. For example, a user's identity may be treated so that no personally identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided and includes processing, using a generative model, input to generate proficiency-specific output that is adapted to a language proficiency of a user for a given language. Processing the input to generate the proficiency-specific output using the generative model includes: processing, using the generative model, the input to generate generic output that is not adapted to the language proficiency of the user for the given language; and processing, using a proficiency-specific model that is specific to the user and for the given language, the generic output, that is not adapted to the language proficiency of the user for the given language, to generate the proficiency-specific output, that is adapted to the language proficiency of the user for the given language.

These and other implementations of technology disclosed herein can optionally include one or more of the following features.

In some implementations, the method can further include receiving user input associated with a client device of a user. The user input can be in a given language, and the input that is processed using the generative model can include the user input.

In some versions of those implementations, the method can further include determining, based on the proficiency-specific output, responsive content that is responsive to the user input; and causing the responsive content to be rendered at the client device of the user.

In some further versions of those implementations, the method can further include receiving additional user input associated with the client device of the user. The additional user input can be in an alternate given language. The method can further include processing, using the generative model, additional input to generate additional proficiency-specific output that is adapted to an alternate language proficiency of the user for the alternate given language. The additional input can be based on at least the additional user input. Processing the additional input to generate the additional proficiency-specific output using the generative model can include processing, using the generative model, the additional input to generate additional generic output that is not adapted to the alternate language proficiency of the user for the alternate given language; and processing, using an alternate proficiency-specific model that is specific to the user and for the alternate given language, the additional generic output, that is not adapted to the alternate language proficiency of the user for the alternate given language, to generate the additional proficiency-specific output, that is adapted to the alternate language proficiency of the user for the alternate given language. The method can further include determining, based on the additional proficiency-specific output, additional responsive content that is responsive to the additional user input; and causing the additional responsive content to be rendered at the client device of the user.

In some yet further versions of those implementations, the alternate given language can be a primary language of the user, wherein the given language is a non-primary language of the user, and wherein the alternate proficiency-specific model differs from the proficiency-specific model.

In additional or alternative further versions of those implementations, the method can further include receiving additional user input associated with the client device of the user. The additional user input can be in the given language. The method can further include processing, using the generative model, additional input to generate additional proficiency-specific output that is adapted to an alternate language proficiency of the user for the given language. The additional input can be based on at least the additional user input. Processing the additional input to generate the additional proficiency-specific output using the generative model can include processing, using the generative model, the additional input to generate additional generic output that is not adapted to the alternate language proficiency of the user for the given language; and processing, using an alternate proficiency-specific model that is specific to the user and for the given language, the additional generic output, that is not adapted to the alternate language proficiency of the user for the given language, to generate the additional proficiency-specific output, that is adapted to the alternate language proficiency of the user for the given language. The method can further include determining, based on the additional proficiency-specific output, additional responsive content that is responsive to the additional user input; and causing the additional responsive content to be rendered at the client device of the user.

In some yet further versions of those implementations, the alternate proficiency-specific model can differ from the proficiency-specific model, the alternate proficiency-specific model can be utilized, in lieu of the proficiency-specific model, based on one or more contextual signals, and the one or more contextual signals can include one or more of: a location of the client device of the user, a time of day, a day of week, or an entry point through which the user input and/or the additional user input is received via the client device.

In some implementations, the method can further include obtaining the input that is processed using the generative model. The input can be obtained from one or more of: prior interactions between the user and the generative model, an online data repository, or a web search.

In some further versions of those implementations, the method can further include determining, based on the proficiency-specific output, content that is based on the input; and causing the content to be rendered at a client device of the user.

In some implementations, the generic output can include a probability distribution over a generic sequence of tokens, and processing the generic output to generate the proficiency-specific output using the proficiency-specific model that is specific to the user and for the given language can include processing, using the proficiency-specific model, the generic sequence of tokens to identify a proficiency-specific sequence of tokens. The proficiency-specific sequence of tokens can be a subset of the generic sequence of tokens.

In some versions of those implementations, the proficiency-specific model can generate a respective proficiency score for each token, included in the generic sequence of tokens, and each token, included in the proficiency-specific sequence of tokens, can be associated with a respective proficiency score that satisfies a proficiency score threshold.

In additional or alternative versions of those implementations, the proficiency-specific model can generate a respective proficiency score for a subsequence of tokens, included in the generic sequence of tokens, and each subsequence of tokens, included in the proficiency-specific sequence of tokens, can be associated with a respective proficiency score that satisfies a proficiency score threshold.

In some further versions of those implementations, the proficiency-specific model can utilize speculative decoding to generate a respective proficiency score for a subsequence of tokens.

In some implementations, the generic output can include a generic probability distribution over a generic sequence of tokens, and processing the generic output to generate the proficiency-specific output using the proficiency-specific model that is specific to the user and for the given language can include processing, using the proficiency-specific model, the generic sequence of tokens to identify a proficiency-specific sequence of tokens. The proficiency-specific sequence of tokens can be over a modified version of the generic probability distribution.

In some versions of those implementations, the proficiency-specific model can generate a respective proficiency score for each token, included in the generic sequence of tokens, and the proficiency-specific model can penalize a respective probability, in the generic probability distribution over the generic sequence of tokens, for each token, included in the generic sequence of tokens, associated with a respective proficiency score that fails to satisfy a proficiency score threshold to generate the modified version of the generic probability distribution.

In some implementations, the generic output can include a probability distribution over a generic sequence of tokens, and the proficiency-specific output can include the probability distribution over a subset of the generic sequence of tokens.

In some implementations, the method can further include, subsequent to generating the proficiency-specific output that is adapted to the language proficiency of the user for the given language: distilling knowledge from adapting the language proficiency of the user for the given language back into the generative model or into an additional generative model. The additional generative model can be in addition to the generative model.

In some versions of those implementations, the method can further include receiving user input associated with a client device of the user. The user input can be in the given language. The method can further include processing, using the generative model or the additional generative model for which the knowledge was distilled, additional input to generate additional proficiency-specific output that is adapted to the language proficiency of the user for the given language. The additional input can be based on at least the user input, and the proficiency-specific model that is specific to the user and for the given language may not be utilized in generating the additional proficiency-specific output. The method can further include determining, based on the additional proficiency-specific output, responsive content that is responsive to the user input; and causing the responsive content to be rendered at the client device of the user.

In some implementations, the method can further include obtaining a plurality of training instances; and training, based on the plurality of training instances, the proficiency-specific model to learn how likely it is that the user will know a particular word or particular phrase. The plurality of training instances can be generated based on prior interactions between the user and the generative model, and the prior interactions between the user and the generative model utilized in generating the plurality of training instances can include one or more of: words utilized by the user in interacting with the generative model, expressions utilized by the user in interacting with the generative model, topics the user asks about in interacting with the generative model, or clarifying questions the user asks in interacting with the generative model.

In some versions of those implementations, the plurality of training instances can include a plurality of positive training instances that are indicative of words or phrases that the user has utilized in interacting with the generative model.

In additional or alternative versions of those implementations, the plurality of training instances can include a plurality of negative training instances that are indicative of words or phrases that the user has asked clarifying questions about in interacting with the generative model.

In some implementations, the generative model can be a first generative model, and the proficiency-specific model can include a second generative model prompted to assess token suitability based on the language proficiency of the user.

In some implementations, the proficiency-specific model can be trained at least in part at a client device of the user.

In some implementations, the proficiency-specific model can include a Low-Rank Adapter.

In some implementations, the one or more processors can be local to the client device of the user.

In some implementations, the input can further include instructions to generate the generic output based on the language proficiency of the user for the given language.

In some implementations, a method implemented by one or more processors is provided and includes processing, using a generative model, input to generate proficiency-specific output that is adapted to a language proficiency of a user for a given language. Processing the input to generate the proficiency-specific output using the generative model includes: processing, using the generative model, the input to generate generic output that is not adapted to the language proficiency of the user for the given language; and filtering, using a proficiency score that is specific to the user and for the given language, the generic output, that is not adapted to the language proficiency of the user for the given language, to generate the proficiency-specific output, that is adapted to the language proficiency of the user for the given language.

These and other implementations of technology disclosed herein can optionally include one or more of the following features.

In some implementations, the method can further include determining the proficiency score that is specific to the user and for the given language. Determining the proficiency score that is specific to the user and for the given language can be based on prior interactions between the user and the generative model, and the prior interactions between the user and the generative model utilized in determining the proficiency score that is specific to the user and for the given language can include one or more of: words utilized by the user in interacting with the generative model expressions utilized by the user in interacting with the generative model, topics the user asks about in interacting with the generative model, or clarifying questions the user asks in interacting with the generative model.

In some versions of those implementations, the method can further include generating, based on the prior interactions between the user and the generative model, a language proficiency distribution that is specific to the user and for the given language; and determining, based on the language proficiency distribution that is specific to the user and for the given language, the proficiency score that is specific to the user and for the given language.

In some implementations, the method can further include receiving user input associated with a client device of a user. The user input can be in a given language, and the input that is processed using the generative model can include the user input.

In some versions of those implementations, the method can further include determining, based on the proficiency-specific output, responsive content that is responsive to the user input; and causing the responsive content to be rendered at the client device of the user.

In additional or alternative versions of those implementations, the method can further include, subsequent to receiving the user input associated with the client device of the user: updating the language proficiency distribution that is specific to the user and for the given language.

In some implementations, a method implemented by one or more processors is provided and includes obtaining a plurality of training instances for training a proficiency-specific model that is specific to a user and that is adapted to a language proficiency of the user for a given language; training, based on the plurality of training instances, the proficiency-specific model to learn how likely it is that the user will know a particular word or particular phrase; and causing the proficiency-specific model to be deployed for utilization in subsequent interactions between the user and the generative model to adapt the subsequent interactions to the language proficiency of the user for the given language. The plurality of training instances are generated based on prior interactions between the user and a generative model, and the prior interactions between the user and the generative model utilized in generating the plurality of training instances include one or more of: words utilized by the user in interacting with the generative model, expressions utilized by the user in interacting with the generative model, topics the user asks about in interacting with the generative model, or clarifying questions the user asks in interacting with the generative model;

These and other implementations of technology disclosed herein can optionally include one or more of the following features.

In some implementations, the plurality of training instances can include a plurality of positive training instances that are indicative of words or phrases that the user has utilized in interacting with the generative model.

In additional or alternative implementations, the plurality of training instances can include a plurality of negative training instances that are indicative of words or phrases that the user has asked clarifying questions about in interacting with the generative model.

In some implementations, the proficiency-specific model can be trained at least in part at a client device of the user.

In some implementations, the proficiency-specific model can include a Low-Rank Adapter.

In some implementations, the generative model can be a first generative model, and the proficiency-specific model can include a second generative model prompted to assess token suitability based on the language proficiency of the user.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform operations of any of the aforementioned methods. Some implementations also include a computer program product including instructions executable by one or more processors to perform operations of any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors, the method comprising:
processing, using a generative model, input to generate proficiency-specific output that is adapted to a language proficiency of a user for a given language, wherein processing the input to generate the proficiency-specific output using the generative model comprises:
processing, using the generative model, the input to generate generic output that is not adapted to the language proficiency of the user for the given language; and
processing, using a proficiency-specific model that is specific to the user and for the given language, the generic output, that is not adapted to the language proficiency of the user for the given language, to generate the proficiency-specific output, that is adapted to the language proficiency of the user for the given language.

2. The method of claim 1, further comprising:
receiving user input associated with a client device of a user, wherein the user input is in a given language, and wherein the input that is processed using the generative model includes the user input.

3. The method of claim 2, further comprising:
determining, based on the proficiency-specific output, responsive content that is responsive to the user input; and
causing the responsive content to be rendered at the client device of the user.

4. The method of claim 3, further comprising:
receiving additional user input associated with the client device of the user, wherein the additional user input is in an alternate given language;
processing, using the generative model, additional input to generate additional proficiency-specific output that is adapted to an alternate language proficiency of the user for the alternate given language, wherein the additional input is based on at least the additional user input, and wherein processing the additional input to generate the additional proficiency-specific output using the generative model comprises:
processing, using the generative model, the additional input to generate additional generic output that is not adapted to the alternate language proficiency of the user for the alternate given language; and
processing, using an alternate proficiency-specific model that is specific to the user and for the alternate given language, the additional generic output, that is not adapted to the alternate language proficiency of the user for the alternate given language, to generate the additional proficiency-specific output, that is adapted to the alternate language proficiency of the user for the alternate given language;
determining, based on the additional proficiency-specific output, additional responsive content that is responsive to the additional user input; and
causing the additional responsive content to be rendered at the client device of the user.

5. The method of claim 4, wherein the alternate given language is a primary language of the user, wherein the given language is a non-primary language of the user, and wherein the alternate proficiency-specific model differs from the proficiency-specific model.

6. The method of claim 3, further comprising:
receiving additional user input associated with the client device of the user, wherein the additional user input is in the given language;
processing, using the generative model, additional input to generate additional proficiency-specific output that is adapted to an alternate language proficiency of the user for the given language, wherein the additional input is based on at least the additional user input, and wherein processing the additional input to generate the additional proficiency-specific output using the generative model comprises:
processing, using the generative model, the additional input to generate additional generic output that is not adapted to the alternate language proficiency of the user for the given language; and
processing, using an alternate proficiency-specific model that is specific to the user and for the given language, the additional generic output, that is not adapted to the alternate language proficiency of the user for the given language, to generate the additional proficiency-specific output, that is adapted to the alternate language proficiency of the user for the given language;
determining, based on the additional proficiency-specific output, additional responsive content that is responsive to the additional user input; and
causing the additional responsive content to be rendered at the client device of the user.

7. The method of claim 6, wherein the alternate proficiency-specific model differs from the proficiency-specific model, wherein the alternate proficiency-specific model is utilized, in lieu of the proficiency-specific model, based on one or more contextual signals, and wherein the one or more contextual signals comprise one or more of: a location of the client device of the user, a time of day, a day of week, or an entry point through which the user input and/or the additional user input is received via the client device.

8. The method of claim 1, further comprising:
obtaining the input that is processed using the generative model, wherein the input is obtained from one or more of: prior interactions between the user and the generative model, an online data repository, or a web search.

9. The method of claim 8, further comprising:
determining, based on the proficiency-specific output, content that is based on the input; and
causing the content to be rendered at a client device of the user.

10. The method of claim 1, wherein the generic output includes a probability distribution over a generic sequence of tokens, and wherein processing the generic output to generate the proficiency-specific output using the proficiency-specific model that is specific to the user and for the given language comprises:
processing, using the proficiency-specific model, the generic sequence of tokens to identify a proficiency-specific sequence of tokens, wherein the proficiency-specific sequence of tokens is a subset of the generic sequence of tokens.

11. The method of claim 10, wherein the proficiency-specific model generates a respective proficiency score for each token, included in the generic sequence of tokens, and wherein each token, included in the proficiency-specific sequence of tokens, is associated with a respective proficiency score that satisfies a proficiency score threshold.

12. The method of claim 10, wherein the proficiency-specific model generates a respective proficiency score for a subsequence of tokens, included in the generic sequence of tokens, and wherein each subsequence of tokens, included in the proficiency-specific sequence of tokens, is associated with a respective proficiency score that satisfies a proficiency score threshold.

13. The method of claim 12, wherein the proficiency-specific model utilizes speculative decoding to generate a respective proficiency score for a subsequence of tokens.

14. The method of claim 1, wherein the generic output includes a generic probability distribution over a generic sequence of tokens, and wherein processing the generic output to generate the proficiency-specific output using the proficiency-specific model that is specific to the user and for the given language comprises:
processing, using the proficiency-specific model, the generic sequence of tokens to identify a proficiency-specific sequence of tokens, wherein the proficiency-specific sequence of tokens is over a modified version of the generic probability distribution.

15. The method of claim 14, wherein the proficiency-specific model generates a respective proficiency score for each token, included in the generic sequence of tokens, and wherein the proficiency-specific model penalizes a respective probability, in the generic probability distribution over the generic sequence of tokens, for each token, included in the generic sequence of tokens, associated with a respective proficiency score that fails to satisfy a proficiency score threshold to generate the modified version of the generic probability distribution.

16. The method of claim 1, wherein the generic output includes a probability distribution over a generic sequence of tokens, and wherein the proficiency-specific output includes the probability distribution over a subset of the generic sequence of tokens.

17. The method of claim 1, wherein the generative model is a first generative model, and wherein the proficiency-specific model comprises a second generative model prompted to assess token suitability based on the language proficiency of the user.

18. The method of claim 1, wherein the proficiency-specific model comprises a Low-Rank Adapter.

19. A system comprising:
at least one processor; and
memory storing instructions that, when executed, cause the at least one processor to be operable to:
process, using a generative model, input to generate proficiency-specific output that is adapted to a language proficiency of a user for a given language, wherein the instructions to process the input to generate the proficiency-specific output using the generative model comprise instructions to:
process, using the generative model, the input to generate generic output that is not adapted to the language proficiency of the user for the given language; and
process, using a proficiency-specific model that is specific to the user and for the given language, the generic output, that is not adapted to the language proficiency of the user for the given language, to generate the proficiency-specific output, that is adapted to the language proficiency of the user for the given language.

20. A non-transitory computer-readable storage medium storing computer-readable instructions that, when executed by at least one processor, cause the at least one processor to execute the computer-readable instructions to:
process, using a generative model, input to generate proficiency-specific output that is adapted to a language proficiency of a user for a given language, wherein the instructions to process the input to generate the proficiency-specific output using the generative model comprise instructions to:
process, using the generative model, the input to generate generic output that is not adapted to the language proficiency of the user for the given language; and
process, using a proficiency-specific model that is specific to the user and for the given language, the generic output, that is not adapted to the language proficiency of the user for the given language, to generate the proficiency-specific output, that is adapted to the language proficiency of the user for the given language.
